(19) United States
(12) Patent Application Publication
(10) Pub. No.: US 2021/0372563 A1
(43) Pub. Date: Dec. 2, 2021

(54) HIGH PRESSURE TANK AND STRAIN DETECTING DEVICE

(71) Applicant: HONDA MOTOR CO., LTD., Tokyo (JP)

(72) Inventors: Toshihiko KANEZAKI, WAKO-SHI (JP); Takanori SUZUKI, WAKO-SHI (JP)

(21) Appl. No.: 17/191,303

(22) Filed: Mar. 3, 2021

(30) Foreign Application Priority Data
Jan. 6, 2020 (JP) 2020-000181

(51) Int. Cl. F17C 1/06; F17C 1/16; F17C 13/02; F17C 13/06

(52) U.S. Cl. CPC F17C 1/06; F17C 1/16; F17C 13/02; F17C 13/06; F17C 2250/0469; F17C 2203/0604; F17C 2203/0673; F17C 2209/227; F17C 2201/0109

(57) ABSTRACT

A high pressure tank includes a liner that is made of resin and stores gas in a high pressure state, and a reinforcing layer that covers an outer surface of the liner. A gas flow path that guides the gas having permeated through the liner to a gas discharge path is formed in between the liner and the reinforcing layer. The gas flow path is constituted by a linear member that is arranged along the outer surface of the liner, and a sheet that is pasted on the outer surface of the liner in a manner that the sheet covers the linear member from the reinforcing layer side, whereby a space through which the gas can flow is formed around the linear member.

### CROSS-REFERENCE TO RELATED APPLICATION

This application is based upon and claims the benefit of priority from Japanese Patent Application No. 2020-000181 filed on Jan. 6, 2020, the contents of which are incorporated herein by reference.

### BACKGROUND OF THE INVENTION

### Field of the Invention

The present invention relates to a high pressure tank that stores gas in a high pressure state, as well as a strain detecting device that detects strains of the high pressure tank.

### Description of the Related Art

In a fuel cell system, hydrogen gas used as a fuel is stored in a high pressure tank. For example, a high pressure tank that is installed in a fuel cell vehicle requires lightness and strength. For this reason, a liner of the high pressure tank is formed of resin; outside of the liner is formed a reinforcing layer that is made up from a reinforcing member such as carbon fiber reinforced plastic (CFRP).

Although a small amount, hydrogen permeates through the liner made of resin and stays in between the liner and the reinforcing layer. Here, gas that has permeated through the liner is called permeation gas. The permeation gas accumulates in between the liner and the reinforcing layer over time. Japanese Laid-Open Patent Publication No. 2011-231900 discloses that microspheres are provided between a liner and a reinforcing layer, whereby an intermediate layer is formed between the liner and the reinforcing layer. The space given as the intermediate layer functions as a gas flow path. The permeation gas flows through the gas flow path and is discharged out of the high pressure tank from around a cap.

### SUMMARY OF THE INVENTION

According to Japanese Laid-Open Patent Publication No. 2011-231900, at the stage where the gas flow path is formed, thermosetting resin (for example, epoxy resin) contained in carbon fiber of the reinforcing layer blocks the gas flow path. Once the gas flow path is blocked, the permeation gas does not flow well and as a result, the permeation gas easily accumulates in the gas flow path. In a state where the permeation gas has accumulated in the gas flow path, if the inner pressure of the liner drops as hydrogen is consumed, the deformation of the liner, namely buckling, can happen.

The present invention has been devised in light of the problems above. An objective of the present invention is to provide a high pressure tank and a strain detecting device that maintain a gas flow path formed between the liner and the reinforcing layer in such good condition that allows gas to pass through the gas flow path easily.

According to the first aspect of the present invention, a high pressure tank including: a liner that is made of resin and configured to store gas in a high pressure state; a reinforcing layer that covers an outer surface of the liner; a cap that is attached to the liner; wherein the cap is formed with a flow hole through which the gas flows from outside of the liner to inside of the liner or from inside of the liner to outside of the liner, and a gas discharge path through which the gas having permeated through the liner flows from in between the liner and the reinforcing layer to the flow hole, a gas flow path configured to guide the gas having permeated through the liner to the gas discharge path is formed in between the liner and the reinforcing layer, the gas flow path is constituted by a linear member that is arranged along the outer surface of the liner, and a sheet that is pasted on the outer surface of the liner in a manner that the sheet covers the linear member from a reinforcing layer side, whereby a space through which the gas can flow is formed around the linear member.

According to the second aspect of the present invention, a strain detecting device that detects a strain of the high pressure tank of the first aspect, wherein the linear member is a wire, and the strain detecting device includes a detector configured to detect expansion and contraction of the wire.

According to the present invention, the gas flow path formed between the liner and the reinforcing layer can keep gas flowing smoothly.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a diagram schematically illustrating a cross section of a high pressure tank;

FIG. 2 is a diagram schematically illustrating a cross section of a cap and a peripheral structure thereof;

FIG. 3 is a diagram schematically illustrating a liner-side end surface of the cap;

FIG. 4 is a diagram schematically illustrating an outer appearance of a liner;

FIG. 5 is a diagram schematically illustrating a cross section taken along line V-V of FIG. 4; and

FIG. 6 is a diagram illustrating the structure of a strain detecting device.

### DESCRIPTION OF THE PREFERRED EMBODIMENTS

Hereinafter, preferred embodiments of a high pressure tank and a strain detecting device according to the present invention will be presented and described in detail with reference to the accompanying drawings.

### 1. Structure of High Pressure Tank 10

In the explanations below, it is supposed that a high pressure tank 10 is used in a fuel cell system of a fuel cell vehicle etc. The fuel cell system generates electric power by supplying hydrogen stored in the high pressure tank 10 and oxygen in the air to a fuel cell stack.

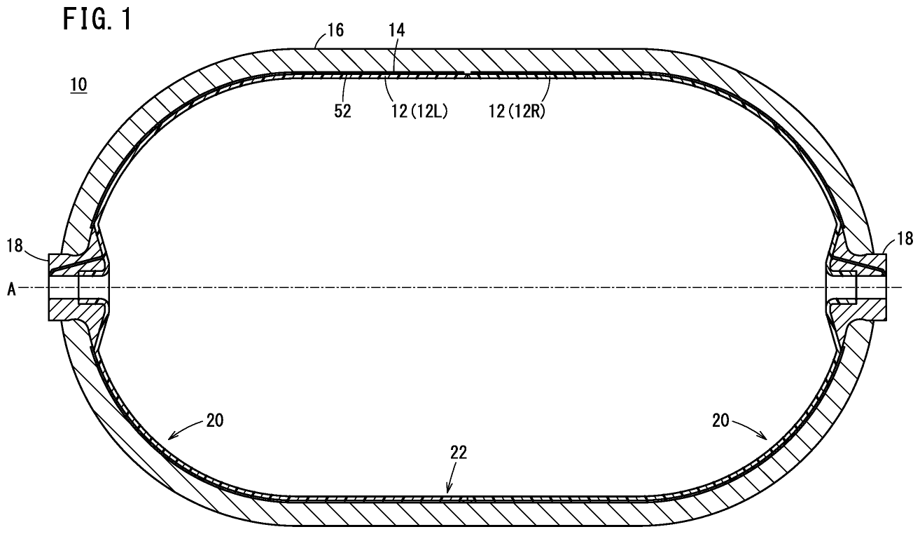

As shown in FIG. 1, the high pressure tank 10 includes a liner 12 that stores hydrogen gas in a high-pressure state, a reinforcing layer 16 that covers an outer surface 14 of the liner 12, and a cap 18 that is attached to the liner 12. The high pressure tank 10 is elongated in the direction where the axial line A extends (in the axial direction).

The liner 12 is formed of resin. The liner 12 includes converging portions 20 located at both ends of the axial direction of the liner 12, and a body portion 22 flanked by the converging portions 20. The converging portions 20 each have a shape that converges on (comes closer to) the axial line A in the direction from a central part of the liner 12 to one end of the liner 12. The body portion 22 has a substantially cylindrical shape with the axial line A being the central axis thereof. For instance, the liner 12 is constituted by two half-bodies 12R, 12L combined at the central part.

The reinforcing layer 16 is formed by a filament winding process. For example, in the filament winding process, while a fibrous reinforcing member is impregnated with thermosetting rein such as epoxy resin, the fibrous reinforcing member is wound around the cap 18 and the outer surface 14 of the liner 12 multiple times to be stacked.

The cap 18 is formed of metal such as aluminum. The caps 18 are attached to both ends of the axial direction of the liner 12 in such a way that the axial line A is located at a central area of the cap 18. The cap 18 may be attached only to one end of the liner 12.

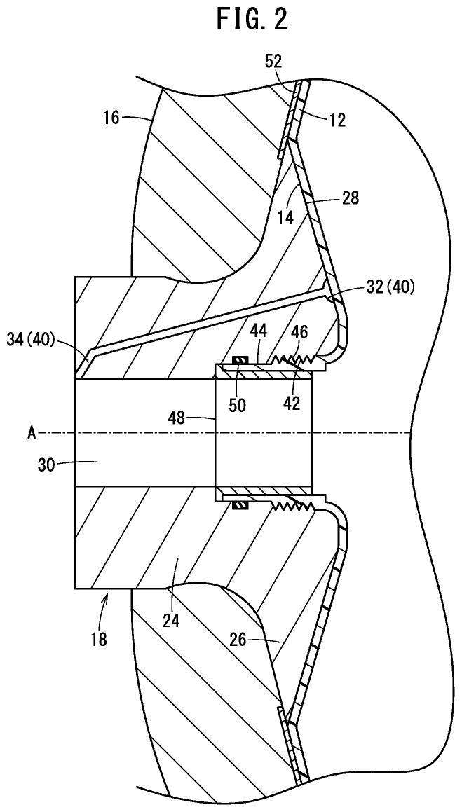

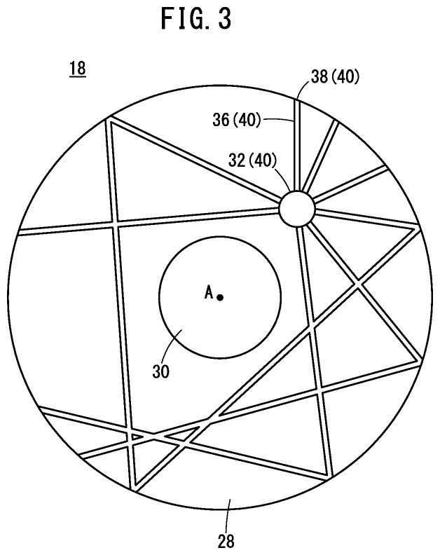

As shown in FIG. 2, the cap 18 includes a cylindrical portion 24 that extends in the axial direction, and a flange portion 26 that expands radially from the liner 12 side end of the cylindrical portion 24. Of the cap 18, a liner side end surface 28 located on the liner 12 side contacts the outer surface 14 of the liner 12. Inside the cap 18, a flow hole 30 that penetrates the cap 18 in the axial direction is formed. Through the flow hole 30, hydrogen gas flows from outside to inside of the liner 12 or from inside to outside of the liner 12. In addition to the flow hole 30, the cap 18 includes, formed therein, a gas discharge hole 34 that connects the flow hole 30 and an opening 32 which is formed in the liner side end surface 28. As shown in FIG. 3, the liner side end surface 28 is also provided with multiple gas discharge grooves 36. The gas discharge grooves 36 are formed between the opening 32 and an inlet 38 through which permeation gas enters and which is located at the edge of the liner side end surface 28. The inlet 38, the gas discharge grooves 36, the opening 32, and the gas discharge hole 34 are collectively called a gas discharge path 40. Through the gas discharge path 40, the permeation gas flows from in between the liner 12 and the reinforcing layer 16 to the flow hole 30.

As shown in FIG. 2, an internal thread 42 is formed on the inner circumference of the flow hole 30. On the other hand, a protruding portion 44 that has been punctured protrudes from the liner 12; and an external thread 46 is formed on the outer circumference of the protruding portion 44. The internal thread 42 of the cap 18 is fit to the external thread 46 of the liner 12, whereby the cap 18 is attached to the liner 12. The protruding portion 44 is reinforced by a collar 48 that is fit to the inner circumference thereof. An O-ring 50 is provided between the cylindrical portion 24 and the protruding portion 44.

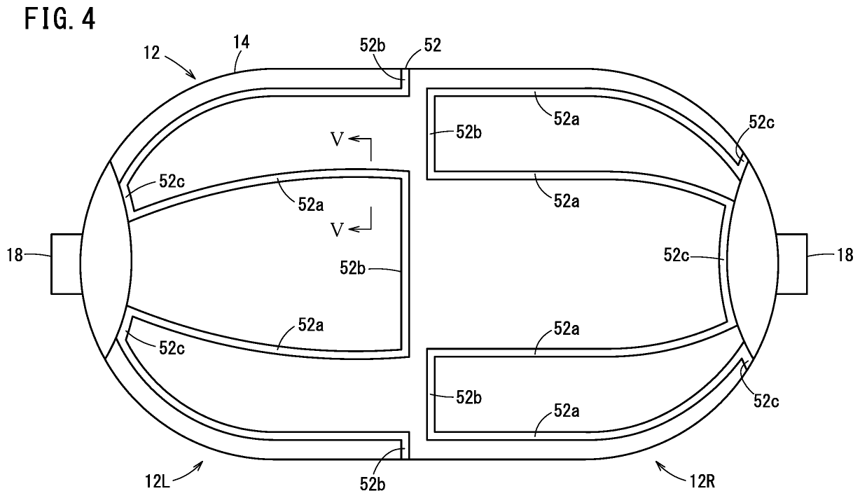

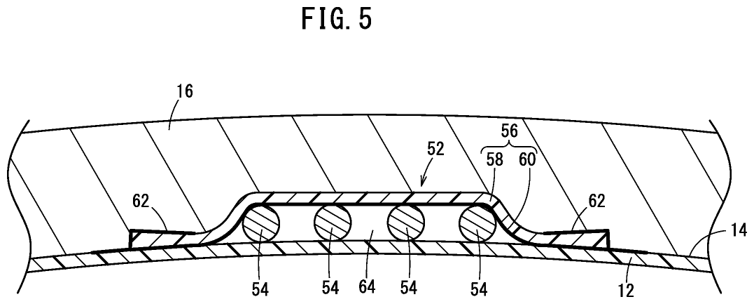

As shown in FIG. 1, a gas flow path 52 is formed between the liner 12 and the reinforcing layer 16. The gas flow path 52 guides the permeation gas to the inlet 38 of the gas discharge path 40 shown in FIG. 3. The gas flow path 52 is explained here with reference to FIGS. 4 and 5.

As shown in FIG. 4, the gas flow paths 52 are formed respectively on the half-body 12R of one liner 12 and the half-body 12L of the other liner 12. The gas flow path 52 includes a first flow path 52a that extends between the center side and one end side of the liner 12, a second flow path 52b that extends in the circumferential direction on the center side of the liner 12, and a third flow path 52c that extends in the circumferential direction on one end side of the liner 12.

The gas flow path 52 is formed by connecting the first flow paths 52a, the second flow paths 52b, and the third flow paths 52c—connecting the first flow path 52a, the second flow path 52b, the first flow path 52a, the third flow path 52c, the first flow path 52a, the second flow path 52b, . . . in this order. All the first flow paths 52a, all the second flow paths 52b, and all the third flow paths 52c may be connected to form one gas flow path 52. The first flow paths 52a, the second flow paths 52b, the third flow paths 52c may be separated into multiple groups to form multiple gas flow paths 52. In the embodiment shown in FIG. 4, the gas flow paths 52 have been formed separately on the half-body 12R and the half-body 12L. However, the gas flow paths 52 may be formed over both the half-body 12R and the half-body 12L. The gas flow path 52 needs to include at least the first flow path 52a. The second flow path 52b and the third flow path 52c are not essential.

Part of the first flow path 52a or part of the third flow path 52c overlaps the inlet 38 formed on the cap 18. In the embodiment shown in FIG. 4, an end of the first flow path 52a and the third flow path 52c overlap the position of the inlet 38, that is, overlap the boundary between the liner 12 and the cap 18. Due to this structure, the permeation gas that flows through the gas flow path 52 is guided to the gas discharge path 40.

As shown in FIG. 5, the gas flow path 52 is constituted by one or more linear members 54 and a sheet 56. The linear members 54 are, for example, wires and are arranged along the outer surface 14 of the liner 12. The direction where the linear members 54 extend is parallel with the direction where the gas flow path 52 extends. From the standpoint of preventing the strength of the high pressure tank 10 from decreasing, thinner linear members 54 are preferable. For example, it is preferable that the diameter of the linear members 54 be equal to or less than 1 mm. The gas flow path 52 depicted in FIG. 5 is formed (supported) by four parallel linear members 54 but may be formed by one linear member 54.

The sheet 56 is made up of a sheet member 58 and adhesive members 60, 62. The sheet member 58 is resin that is liquid-repellent with respect to resin material with which the fibrous reinforcing member is impregnated; for example, the sheet member 58 is made of PTFE. The adhesive members 60, 62 are tape-shaped members; for example, the adhesive members 60, 62 are made of resin that has approximately the same elastic modulus as the liner 12. The sheet 56 may be constituted by a sticky sheet member 58 instead of the sheet member 58 and the adhesive members 60, 62.

The adhesive member 60 is pasted on the linear member 54 and the outer surface 14 of the liner 12 in such a way that the adhesive member 60 covers the linear member 54 from the reinforcing layer 16 side. The sheet member 58 covers the adhesive member 60 from the reinforcing layer 16 side. The adhesive member 62 is pasted on the sheet member 58 and the outer surface 14 of the liner 12 in such a way that the adhesive member 62 covers the boundary between the sheet member 58 and the outer surface 14 of the liner 12. In this way, the sheet 56 is pasted on the outer surface 14 of the liner 12, whereby a space 64 demarcated by the liner 12 and the sheet 56 is formed around the linear members 54. The permeation gas flows through the space 64.

### 2. Flow of Permeation Gas

Hydrogen gas stored in the liner 12 permeates through the liner 12 over time. The permeation gas accumulated in between the liner 12 and the reinforcing layer 16 permeates through the sheet 56 and flows into the space 64 of the gas flow path 52. The permeation gas also directly flows into the space 64 of the gas flow path 52 from the liner 12. The permeation gas inside the second flow path 52b flows toward the first flow path 52a. The permeation gas inside the first flow path 52a flows toward the third flow path 52c. The permeation gas inside the third flow path 52c flows into the inlet 38 and flows through the gas discharge path 40, more specifically, through the gas discharge groove 36, the opening 32, and the gas discharge hole 34 in this order, and is then discharged into the flow hole 30.

### 3. Strain Detecting Device 70

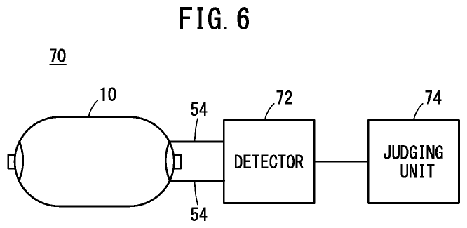

The linear member 54, which is a wire, also functions as a strain gauge. With reference to FIG. 6, a strain detecting device 70 that uses the linear member 54 as a strain gauge is explained.

The strain detecting device 70 includes the linear member 54 that is pasted on the high pressure tank 10, a detector 72 that detects expansion and contraction of the linear member 54, and a judging unit 74 that judges strains based on a signal output by the detector 72. The detector 72 includes a bridge circuit connected to both ends of one linear member 54, an amplifier that amplifies an output signal from the bridge circuit, an A/D converter that converts an output from the amplifier into a digital signal, and so on. The judging unit 74 is constituted by, for example, a personal computer.

When buckling occurs at the liner 12, the linear member 54 expands and contracts as the liner 12 deforms. Buckling tends to occur at a central portion of the axial direction of the liner 12. For this reason, the linear member 54 provided inside the first flow path 52a or the third flow path 52c expands or contracts. The detector 72 detects a resistance value of the linear member 54. When the resistance value detected by the detector 72 exceeds a given range, the judging unit 74 determines that a strain has occurred in the liner 12.

### 4. Modified Example

When the heat conductivity of the linear member 54 is high and the linear member 54 is in contact with the cap 18, heat outside the high pressure tank 10 can be conducted to the outer surface 14 of the liner 12 through the cap 18 and the linear member 54.

In the above embodiments, the high pressure tank 10 used in the fuel cell system in the fuel cell vehicle etc. has been explained. However, the present invention is not limited to this example. The high pressure tank 10 may store gas other than hydrogen gas.

### 5. Technical Ideas Obtained from Embodiments

The aspects of the invention will be described below as the technical ideas that ca be grasped from the above embodiments.

According to the first aspect of the present invention, the high pressure tank 10 includes: a liner 12 that is made of resin and configured to store gas in a high pressure state; a reinforcing layer 16 that covers an outer surface 14 of the liner 12; a cap 18 that is attached to the liner 12; wherein the cap 18 is formed with a flow hole 30 through which the gas flows from outside of the liner 12 to inside of the liner 12 or from inside of the liner 12 to outside of the liner 12, and a gas discharge path 40 through which the gas having permeated through the liner 12 flows from in between the liner 12 and the reinforcing layer 16 to the flow hole 30, a gas flow path 52 configured to guide the gas having permeated through the liner 12 to the gas discharge path 52 is formed in between the liner 12 and the reinforcing layer 16, the gas flow path 52 is constituted by a linear member 54 that is arranged along the outer surface 14 of the liner 12, and a sheet 56 that is pasted on the outer surface 14 of the liner 12 in a manner that the sheet 56 covers the linear member 54 from the reinforcing layer 16 side, whereby a space 64 through which the gas can flow is formed around the linear member 54.

According to this structure, since the gas flow path 52 is formed along the outer surface 14 of the liner 12, the permeation gas can flow through the gas discharge path 40 formed in the cap 18.

Moreover, according to this structure, the space 64 closed by the liner 12 and the sheet 56 is formed as the gas flow path 52. Thus, it is possible to prevent epoxy resin contained in the reinforcing layer 16 (CFRP) from blocking the gas flow path 52 and deteriorating smooth passage of gas. In addition, even if high pressure occurs around the gas flow path 52, the linear member 54 keeps the space 64 inside the gas flow path 52 as it is, and thus it is possible to prevent the gas flow path 52 from being pressed and blocked and deteriorating smooth passage of gas. As a result, smooth passage of gas through the gas flow path 52 formed between the liner 12 and the reinforcing layer 16 can be maintained.

When the high pressure tank 10 is installed in a fuel cell vehicle, it is possible to reduce a permissible lower limit on the inner pressure of the liner 12 by efficiently discharging the permeation gas. As a result, it becomes possible to use more hydrogen gas stored in the high pressure tank 10, whereby a cruising range of the fuel cell vehicle can be extended (the fuel cell vehicle can drive a longer distance).

Moreover, according to the structure above, the sheet 56 is interposed between the linear member 54 and the reinforcing layer 16. As a result, it is possible to prevent damage to the reinforcing layer 16 that are caused when the linear member 54 and the reinforcing layer 16 rub each other as the liner 12 expands or contracts.

In the first aspect, the gas flow path 52 may be formed by a plurality of the linear members 54 that extend together with the gas flow path 52, and two adjacent linear members 54 of the linear members may be parallel.

According to the above structure, the space 64 within the gas flow path 52 can be made larger by multiple linear members 54, whereby flowing of gas is facilitated.

In the first aspect, of the cap 18, a portion (liner side end surface 28) that faces the liner 12 may be formed with an inlet 38 of the gas discharge path 40, and part of the gas flow path 52 may overlap the inlet 38 of the gas discharge path 40.

According to the above structure, since part of the gas flow path 52 overlaps the inlet 38 of the gas discharge path 40, it is possible to prevent resin from flowing in between the gas flow path 52 and the gas discharge path 40 when the tank is manufactured. Moreover, according to the above structure, gas having permeated through the liner 12 can flow suitably from the gas flow path 52 to the gas discharge path 40.

In the first aspect, the liner 12 may include converging portions 20 that are located at both ends of an axial direction of the liner 12, and a body portion 22 that is flanked by the converging portions 20, and part of the gas flow path 52 may extend in a circumferential direction of the body portion 22.

Buckling of the liner 12 occurs mainly at the body portion 22 of the liner 12. According to the above structure, a strain in the circumferential direction of the body portion 22 can be detected.

In the first aspect, the sheet 56 may include a sheet member 58 that is arranged on the reinforcing layer 16 side, and a tape-shaped adhesive member 60 that is arranged on the liner 12 side, the sheet member 58 may be resin that is liquid-repellent with respect to resin material with which fibrous reinforcing member is impregnated, and the adhesive member 60 may be resin that has the same elastic modulus as the liner 12.

According to the above structure, since the sheet member 58 is liquid-repellent, epoxy resin contained in the reinforcing layer 16 (CFRP) can be prevented from flowing into the gas flow path 52. Since the adhesive member 60 is a resin that has the same elastic modulus as the liner 12, the adhesive member 60 can deform following the expansion and contraction of the liner 12. Therefore, it is possible to prevent the sheet 56 from peeling off and being damaged due to expansion and contraction of the liner 12.

According to the second aspect of the present invention, a strain detecting device 70 that detects strains of the high pressure tank 10 of the first aspect, wherein the linear member 54 is a wire, and the strain detecting device includes a detector 72 that detects expansion and contraction of the wire.

According to the above structure, since the linear member 54 that is a component of the gas flow path 52 also has a function of detecting strains (buckling etc.) of the liner 12, there is no need to provide the liner 12 with a member that detects the strains.

The high pressure tank and the strain detecting device according to the present invention is not limited to the above-described embodiment, and various modifications can be made without departing from the gist of the present invention.

What is claimed is:

1. A high pressure tank comprising:
a liner that is made of resin and configured to store gas in a high pressure state;
a reinforcing layer that covers an outer surface of the liner; and
a cap that is attached to the liner,
wherein
the cap is formed with
a flow hole through which the gas flows from outside of the liner to inside of the liner or from inside of the liner to outside of the liner, and
a gas discharge path through which the gas having permeated through the liner flows from in between the liner and the reinforcing layer to the flow hole,
a gas flow path configured to guide the gas having permeated through the liner to the gas discharge path is formed in between the liner and the reinforcing layer,
the gas flow path is constituted by
a linear member that is arranged along the outer surface of the liner, and
a sheet that is pasted on the outer surface of the liner in a manner that the sheet covers the linear member from a reinforcing layer side, whereby a space through which the gas is flowable is formed around the linear member.

2. The high pressure tank according to claim 1, wherein
the linear member comprises a plurality of linear members that extend together with the gas flow path, and the gas flow path is formed by the plurality of linear members, and
two adjacent linear members of the linear members are parallel.

3. The high pressure tank according to claim 1, wherein
a portion of the cap that faces the liner is formed with an inlet of the gas discharge path, and
part of the gas flow path overlaps the inlet of the gas discharge path.

4. The high pressure tank according to claim 1, wherein
the liner includes
converging portions that are located at both ends of an axial direction of the liner, and
a body portion that is flanked by the converging portions, and
part of the gas flow path extends in a circumferential direction of the body portion.

5. The high pressure tank according to claim 1, wherein
the sheet includes
a sheet member that is arranged on the reinforcing layer side, and
a tape-shaped adhesive member that is arranged on a liner side,
the sheet member is resin that is liquid-repellent with respect to resin material with which fibrous reinforcing member is impregnated, and
the adhesive member is resin that has a same elastic modulus as the liner.

6. A strain detecting device that detects a strain of a high pressure tank,
the high pressure tank comprising:
a liner that is made of resin and configured to store gas in a high pressure state;
a reinforcing layer that covers an outer surface of the liner; and
a cap that is attached to the liner;
wherein
the cap is formed with
a flow hole through which the gas flows from outside of the liner to inside of the liner or from inside of the liner to outside of the liner, and
a gas discharge path through which the gas having permeated through the liner flows from in between the liner and the reinforcing layer to the flow hole,
a gas flow path configured to guide the gas having permeated through the liner to the gas discharge path is formed in between the liner and the reinforcing layer,
the gas flow path is constituted by
a linear member that is arranged along the outer surface of the liner, and
a sheet that is pasted on the outer surface of the liner in a manner that the sheet covers the linear member from a reinforcing layer side, whereby a space through which the gas is flowable is formed around the linear member; and
wherein
the linear member is a wire, and
the strain detecting device comprises a detector configured to detect expansion and contraction of the wire.
